(19) United States
(12) Patent Application Publication
(10) Pub. No.: US 2020/0127309 A1
(43) Pub. Date: Apr. 23, 2020

(54) FUEL CELL SYSTEM AND FUEL CELL SYSTEM CONTROL METHOD

(71) Applicant: HONDA MOTOR CO., LTD., Tokyo (JP)

(72) Inventors: Ryoji Sakai, Wako-shi (JP); Akihiro Matsui, Wako-shi (JP); Kuniaki Ojima, Wako-shi (JP)

(21) Appl. No.: 16/655,291

(22) Filed: Oct. 17, 2019

(30) Foreign Application Priority Data
Oct. 19, 2018 (JP) 2018-197933

(51) Int. Cl. H01M 8/04223; H01M 8/04858; H01M 8/04701

(52) U.S. Cl. CPC H01M 8/04268; H01M 8/04701; H01M 8/04888

(57) ABSTRACT

An FC control unit selectively supplies electrical power of an FC unit to one or both of a battery and a battery heater, based on at least one of whether an SOC of the battery is higher or lower than a preset threshold value, and whether a battery temperature is higher or lower than a preset temperature threshold.

### CROSS-REFERENCE TO RELATED APPLICATION

This application is based upon and claims the benefit of priority from Japanese Patent Application No. 2018-197933 filed on Oct. 19, 2018, the contents of which are incorporated herein by reference.

### BACKGROUND OF THE INVENTION

### Field of the Invention

The present invention relates to a fuel cell system and a fuel cell system control method.

### Description of the Related Art

The fuel cell system disclosed in Japanese Laid-Open Patent Publication No. 2008-103228 has the object of causing the temperature of a secondary battery to be raised quickly to a predetermined temperature, while ensuring the power generation capability and durability of a fuel cell stack, in the case that the secondary battery is undergoing a warm-up process (see paragraph [0010] and abstract). In order to realize such an object, in the aforementioned fuel cell system, there are carried out repeatedly a first process for controlling a power distribution unit so as to supply the electrical power generated by the fuel cell stack to auxiliary equipment and the secondary battery, and a second process for controlling the power distribution unit so as to supply the electrical power generated by the fuel cell stack and the electrical power discharged by the secondary battery to the auxiliary equipment. When the second process is performed, the control unit controls a flow rate control valve provided in a bypass flow passage that is branched from an oxygen-containing gas supply flow passage, whereby a portion of the air discharged from an air compressor is discharged to the exterior through a bypass flow path without passing through the interior of the fuel cell stack.

### SUMMARY OF THE INVENTION

However, in the conventional fuel cell system, in the case that electrical power is generated simply in accordance with a driving force requirement, there is a problem in that time is required for warming up the fuel cell. Conversely, when priority is placed on controlling warming up of the fuel cell, there is a concern that the driving force requirement may be insufficient.

The present invention has been devised taking into consideration the aforementioned problems, and has the object of providing a fuel cell system and a fuel cell system control method, in which it is possible to realize an improvement in warm-up performance along with generating electrical power corresponding to a driving force requirement, thereby enabling a reduction in the frequency at which the driving force is limited.

A fuel cell system according to the present invention comprises a load, a fuel cell connected to the load and configured to selectively supply electrical power to the load, a battery connected to the load and configured to selectively supply electrical power to the load, a battery heater configured to supply heat to the battery, and a power control unit configured to perform at least a warm-up control of the fuel cell, wherein the power control unit selectively supplies the electrical power of the fuel cell to one or both of the battery and the battery heater, based on at least one of whether a state of charge of the battery is higher or lower than a preset threshold value, and whether a battery temperature is higher or lower than a preset threshold temperature.

In a method of controlling a fuel cell system according to the present invention, the fuel cell system comprises a load, a fuel cell connected to the load and configured to selectively supply electrical power to the load, a battery connected to the load and configured to selectively supply electrical power to the load, a battery heater configured to supply heat to the battery, and a power control unit configured to perform at least a warm-up control of the fuel cell, wherein the method of controlling the fuel cell system comprises selectively supplying the electrical power of the fuel cell to one or both of the battery and the battery heater, based on at least one of whether a state of charge of the battery is higher or lower than a preset threshold value, and whether a battery temperature is higher or lower than a preset threshold temperature.

According to the present invention, it is possible to realize an improvement in warm-up performance along with generating electrical power corresponding to a driving force requirement, thereby enabling a reduction in the frequency at which the driving force is limited.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic overall configuration diagram of a fuel cell vehicle equipped with a fuel cell system according to an embodiment of the present invention;

FIG. 2 is a schematic overall configuration diagram of an FC unit of the embodiment;

FIG. 3A is an explanatory diagram showing a relationship for an amount of generated heat required by a warm-up control at a time of normal operation;

FIG. 3B is an explanatory diagram showing a relationship for an amount of generated heat required by the warm-up control in the case it is desired to enhance the warm-up performance;

FIG. 4 is a table showing an example of a case classification according to an increase or decrease in a battery temperature and an increase or decrease in a battery SOC level;

FIG. 5 is a flowchart showing processing operations preformed by an FC control unit;

FIG. 6 is a time chart showing movements of respective parameters in a first case;

FIG. 7 is a time chart showing movements of respective parameters in a second case;

FIG. 8 is a time chart showing movements of respective parameters in a third case; and

FIG. 9 is a time chart showing movements of respective parameters in a fourth case.

### DESCRIPTION OF THE PREFERRED EMBODIMENTS

A preferred embodiment of the present invention will be presented and described in detail below with reference to the accompanying drawings.

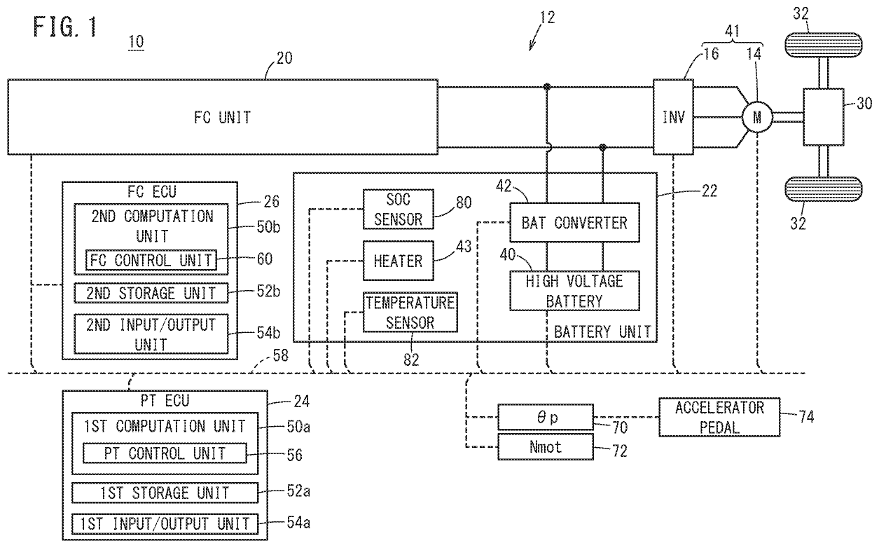

A fuel cell system 10 (hereinafter referred to as an “FC system 10”) according to the present embodiment will be described with reference to FIGS. 1 to 9.

First, as shown in FIG. 1, a fuel cell vehicle 12 (hereinafter simply referred to as a “vehicle 12”) applied to the FC system 10 includes, in addition to the FC system 10, a traction motor 14 (hereinafter referred to as a “motor 14”), and an inverter 16.

The FC system 10 includes a fuel cell unit 20 (hereinafter referred to as an “FC unit 20”), a battery unit 22, a power train electronic control unit (hereinafter referred to as a “PT ECU 24”), and a fuel cell unit ECU (hereinafter referred to as an “FC ECU 26”).

The motor 14 of the present embodiment is a three-phase AC brushless type motor. The motor 14 generates a drive power based on the combined power supplied from the FC unit 20 and the battery unit 22. Vehicle wheels 32 are rotated by the drive power through a transmission 30. Further, the motor 14 outputs electrical power (regenerative electrical power), which is generated by carrying out power regeneration, to the battery unit 22, etc.

The inverter 16 has, for example, a three-phase full-bridge configuration, and performs DC to AC conversion. More specifically, the inverter 16 converts a direct current into a three-phase alternating current, and supplies the alternating current to the motor 14. Further, the inverter 16 supplies a direct current, after AC to DC conversion is performed accompanying a regenerative operation, to a high voltage battery 40 (hereinafter also referred to as a “battery 40”) through a battery converter 42 of the battery unit 22. Moreover, the motor 14 and the inverter 16 taken in combination are referred to as a load 41.

As shown in FIG. 1, the battery unit 22 includes a battery 40, the battery converter 42, and a battery heater 43. The battery 40 is an electrical power storage device (energy storage) including a plurality of battery cells, and for example, can make use of a lithium ion secondary battery, a nickel-hydrogen secondary battery, or the like. Instead of the battery 40, an electrical power storage device such as a capacitor or the like may be used.

The battery converter 42 is a step-up chopper type voltage converter (DC/DC converter). More specifically, the battery converter 42 elevates the output voltage (battery voltage) of the battery 40, or supplies the output voltage to the inverter 16 in a directly connected state. Further, in the directly connected state, the battery converter 42 is capable of supplying the regenerative voltage of the motor 14 or the FC voltage to the battery 40.

The PT ECU 24 includes a first computation unit 50a, a first storage unit 52a, and a first input/output unit 54a. The first computation unit 50a includes a power train control unit (PT control unit 56). More specifically, the PT ECU 24 functions as the PT control unit 56 by executing a program that is stored in the first storage unit 52a. The PT control unit 56 controls the motor 14, the inverter 16, and the battery unit 22 via the first input/output unit 54a and a communication line 58.

The FC ECU 26 includes a second computation unit 50b, a second storage unit 52b, and a second input/output unit 54b. The second computation unit 50b includes a fuel cell control unit (FC control unit 60). More specifically, the FC ECU 26 functions as an FC control unit 60 by executing a program that is stored in the second storage unit 52b. The FC control unit 60 controls the FC unit 20 via the second input/output unit 54b and the communication line 58.

As various types of sensors, there are included a degree of opening sensor 70, and a motor rotational speed sensor 72. The degree of opening sensor 70 detects the degree of opening θp of an accelerator pedal 74. The motor rotational speed sensor 72 detects the speed of rotation (“motor rotational speed Nmot”) of the motor 14. Further, as various types of sensors, there are included an SOC sensor 80 that detects the SOC (state of charge) of the battery 40, and a temperature sensor 82 that detects the temperature of the battery 40.

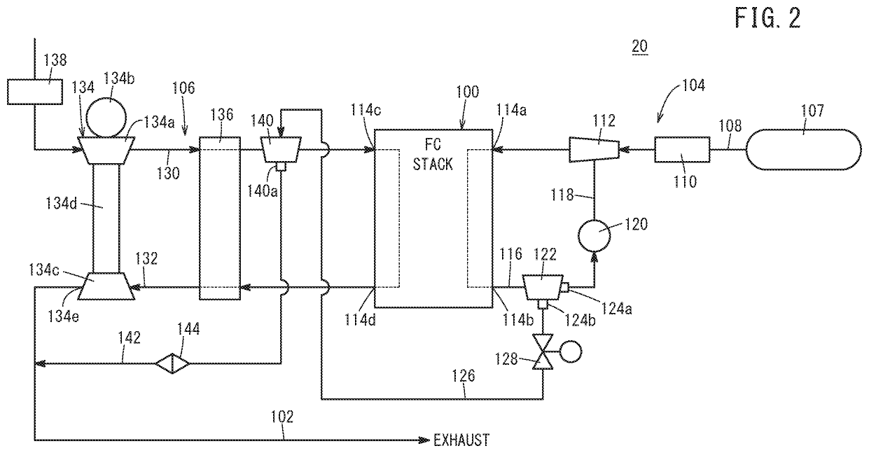

As shown in FIG. 2, the FC unit 20 comprises a fuel cell stack (hereinafter referred to as an “FC stack 100”) that carries out generation of electrical power using a fuel gas and an oxygen-containing gas, and an exhaust pipe 102 for discharging to the exterior of the vehicle a cathode exhaust gas that has flowed out from the FC unit 20.

The FC unit 20 is further equipped with a fuel gas supply device 104 that supplies a fuel gas (for example, hydrogen gas) to the FC stack 100, and an oxygen-containing gas supply device 106 that supplies air, which is an oxygen-containing gas, to the FC stack 100. Although illustration thereof is omitted, the fuel cell system 10 is further equipped with a coolant supply device that supplies a coolant to the FC stack 100.

Each of the power generation cells that constitute the FC stack 100 includes a membrane electrode assembly and a pair of separators that sandwich the membrane electrode assembly from both sides. The membrane electrode assembly is constituted by arranging an anode and a cathode on both surfaces of an electrolyte membrane (for example, a solid polymer electrolyte membrane).

The fuel gas supply device 104 includes a fuel gas tank 107, a fuel gas supply line 108, an injector 110, and an ejector 112. The fuel gas tank 107 stores a high-pressure fuel gas (high-pressure hydrogen). The fuel gas supply line 108 guides the fuel gas to the FC stack 100. The injector 110 is provided in the fuel gas supply line 108. The ejector 112 is disposed on a downstream side from the injector 110.

A fuel gas discharge line 116 is connected to a fuel gas outlet port 114b of the FC stack 100. The fuel gas discharge line 116 directs an anode exhaust gas (fuel off gas), which is a fuel gas that has been at least partially used in the anodes of the FC stack 100, outwardly from the FC stack 100. A circulation line 118 is connected to the fuel gas discharge line 116. The circulation line 118 guides the anode exhaust gas to the ejector 112. A hydrogen pump 120 (circulation pump) is disposed in the circulation line 118. It should be noted that the hydrogen pump 120 need not necessarily be provided.

A gas-liquid separator 122 is disposed in the fuel gas discharge line 116. A connection line 126 is connected to a liquid discharge port 124b of the gas-liquid separator 122. A drain valve 128, which is controlled to be opened and closed by the FC ECU 26 (see FIG. 1), is provided in the connection line 126.

The oxygen-containing gas supply device 106 includes an oxygen-containing gas supply line 130, an oxygen-containing gas discharge line 132, an air pump 134, and a humidifier 136. The oxygen-containing gas supply line 130 is connected to an oxygen-containing gas inlet port 114c of the fuel cell stack 100. The oxygen-containing gas discharge line 132 is connected to an oxygen-containing gas outlet port 114d of the fuel cell stack 100. The air pump 134 supplies air toward the fuel cell stack 100. The humidifier 136 humidifies the air supplied to the fuel cell stack 100.

The air pump 134 includes a compressor 134a that compresses air, a motor 134b that rotatably drives the compressor 134a, and an expander 134c (regenerating mechanism) coupled to the compressor 134a. The air pump 134 is controlled by the FC ECU 26. The compressor 134a is disposed in the oxygen-containing gas supply line 130. In the oxygen-containing gas supply line 130, an air cleaner 138 is disposed on a more upstream side than the compressor 134a. Air is introduced into the compressor 134a through the air cleaner 138.

The expander 134c is disposed in the oxygen-containing gas discharge line 132. An impeller of the expander 134c is connected via a connecting shaft 134d to an impeller of the compressor 134a. The impeller of the compressor 134a, the connecting shaft 134d, and the impeller of the expander 134c rotate integrally about an axis of rotation. The cathode exhaust gas is introduced into the impeller of the expander 134c, and fluid energy is regenerated from the cathode exhaust gas. The regenerative energy covers a portion of the driving force for rotating the compressor 134a.

The humidifier 136 includes a large number of hollow fiber membranes through which moisture can permeate. By way of such hollow fiber membranes, moisture is exchanged between the air directed toward the FC stack 100, and the high humidity cathode exhaust gas discharged from the FC stack 100, whereby the air directed toward the FC stack 100 is humidified.

In the oxygen-containing gas supply line 130, a gas-liquid separator 140 is disposed between the humidifier 136 and the oxygen-containing gas inlet port 114c of the FC stack 100. The connection line 126 is connected to the gas-liquid separator 140. One end of a drain pipe 142 is connected to a liquid discharge port 140a of the gas-liquid separator 140. Another end of the drain pipe 142 is connected to the exhaust pipe 102. An orifice 144 is disposed in the drain pipe 142. It should be noted that the gas-liquid separator 140 need not necessarily be provided. In the case that the gas-liquid separator 140 is not provided, the connection line 126 may be directly connected to the oxygen-containing gas supply line 130.

The exhaust pipe 102 is connected to an outlet port 134e of the expander 134c. The exhaust pipe 102 extends from the outlet port 134e of the expander 134c, and extends to a rear part of the vehicle body along a bottom portion of the vehicle body.

Next, a description will be given of operations of the fuel cell system 10 which is configured in the manner described above.

At a time of normal operation, the fuel cell system 10 operates in the following manner. As shown in FIG. 2, in the fuel gas supply device 104, the fuel gas is supplied from the fuel gas tank 107 to the fuel gas supply line 108. At this time, the fuel gas is injected by the injector 110 toward the ejector 112, and via the ejector 112, is introduced from a fuel gas inlet port 114a into a fuel gas flow passage inside the FC stack 100, and is supplied to the anodes.

On the other hand, in the oxygen-containing gas supply device 106, under a rotating action of the air pump 134 (compressor 134a), air which forms the oxygen-containing gas is delivered to the oxygen-containing gas supply line 130. After being humidified by the humidifier 136, the air is introduced from the oxygen-containing gas inlet port 114c into an oxygen-containing gas flow passage inside the FC stack 100, and is supplied to the cathodes. In each of the power generation cells, the fuel gas supplied to the anodes, and the oxygen contained within the air supplied to the cathodes are partially consumed by electrochemical reactions within the electrode catalyst layers, whereby generation of electrical power is carried out.

Fuel gas that has not been consumed at the anodes is discharged from the fuel gas outlet port 114b into the fuel gas discharge line 116 as an anode exhaust gas. Liquid water discharged from the anodes is introduced into the gas-liquid separator 122 together with the anode exhaust gas. The anode exhaust gas is separated from the liquid water by the gas-liquid separator 122, and the anode exhaust gas flows into the circulation line 118 via a gas discharge port 124a of the gas-liquid separator 122. Based on an instruction from the FC ECU 26, the amount of liquid inside the gas-liquid separator 122 is adjusted by opening or closing the drain valve 128. Moreover, when operation of the FC stack 100 is stopped, the drain valve 128 is opened, and the liquid water inside the gas-liquid separator 122 is discharged by gravity through the connection line 126 into the gas-liquid separator 140 that is provided in the oxygen-containing gas supply line 130. The liquid water is discharged from the gas-liquid separator 140 to the exterior of the vehicle via the drain pipe 142 and the exhaust pipe 102.

The anode exhaust gas is introduced into the ejector 112 from the fuel gas discharge line 116 via the circulation line 118. The anode exhaust gas introduced into the ejector 112 is mixed with the fuel gas that is injected by the injector 110, and the mixed gas is supplied to the FC stack 100.

From the oxygen-containing gas outlet port 114d of the FC stack 100, a humidified cathode exhaust gas, which contains oxygen that has not been consumed at the cathodes, and water, which is a reaction product produced at the cathodes, are discharged into the oxygen-containing gas discharge line 132. After exchange of moisture with the air directed toward the FC stack 100 is carried out in the humidifier 136, the cathode exhaust gas is introduced into the expander 134c of the air pump 134. In the expander 134c, recovery (regeneration) of energy from the cathode exhaust gas is carried out, and the regenerative energy becomes a portion of the driving force for the compressor 134a. The cathode exhaust gas and water are discharged from the expander 134c into the exhaust pipe 102, and are released to the exterior of the vehicle through the exhaust pipe 102.

When the fuel cell system 10 is initiated, in the case that the FC ECU 26 determines that warming up of the FC stack 100 is required on the basis of the temperature, the warm-up operation is performed prior to the normal operation. During the warm-up operation, by an instruction from the FC ECU 26, the drain valve 128 provided in the connection line 126 that is connected to the gas-liquid separator 122 is opened. In addition, in the same manner as in the normal operation, the fuel gas is supplied to the anodes of the FC stack 100 by the fuel gas supply device 104, together with the oxygen-containing gas being supplied to the cathodes of the FC stack 100 by the oxygen-containing gas supply device 106, whereby generation of electrical power is carried out.

Since the drain valve 128 is opened, the fuel gas is introduced into the oxygen-containing gas supply line 130 via the connection line 126. Accordingly, the fuel gas is supplied together with the oxygen-containing gas to the cathodes of the FC stack 100. As a result, by the oxygen-containing gas and the fuel gas, an exothermic reaction (catalytic combustion) is generated at the cathode catalyst. The FC stack 100 is rapidly heated by heat accompanying the exothermic reaction, and by heat accompanying the generation of power. In addition, in the case it is determined that a warm-up completion temperature has been reached, the drain valve 128 is closed, and the process transitions to the above-described normal operation.

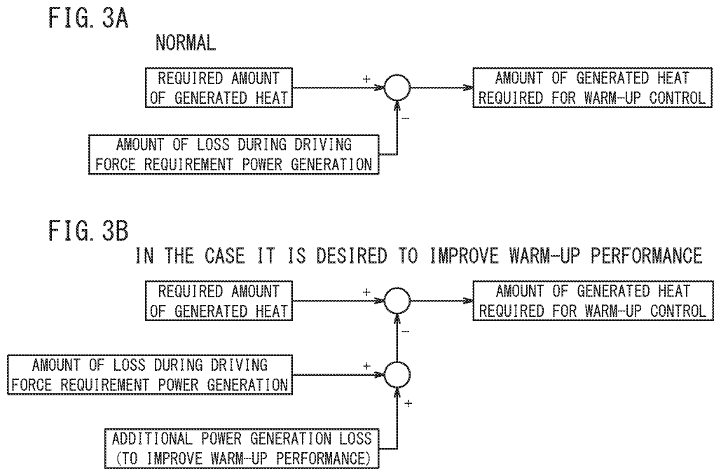

In the above-described normal operation, for example as shown in FIG. 3A, the amount of generated heat, which is obtained by subtracting from the required amount of generated heat an amount of loss during power generation based on the driving force requirement, is controlled to become an amount of generated heat required for the warm-up control. Stated otherwise, an amount of heat obtained by adding the amount of loss during power generation based on the driving force requirement and the amount of generated heat required by the warm-up control becomes the required amount of generated heat.

Further, as shown in FIG. 3B, in the case it is desired to improve the warm-up performance, the amount of generated heat, which is obtained by subtracting from the required amount of generated heat a total amount of loss (the loss during power generation based on the driving force requirement+a loss due to additional power generation to improve the warm-up performance), is controlled so as to become an amount of generated heat required for the warm-up control. Stated otherwise, an amount of heat obtained by adding the aforementioned total amount of loss and the amount of generated heat required by the warm-up control becomes the required amount of generated heat.

In addition, the FC control unit 60 (power control unit) selectively supplies electrical power of the fuel cell to one or both of the battery 40 and the battery heater 43, based on at least one of whether the SOC of the battery 40 is higher or lower than a preset threshold value, and whether the battery temperature is higher or lower than a preset temperature threshold. Further, the FC control unit 60 acquires the SOC of the battery 40 based on a detection signal from the SOC sensor 80, and acquires the battery temperature based on a detection signal from the temperature sensor 82.

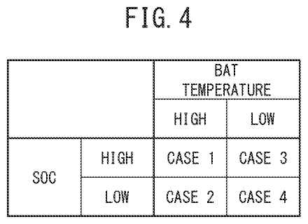

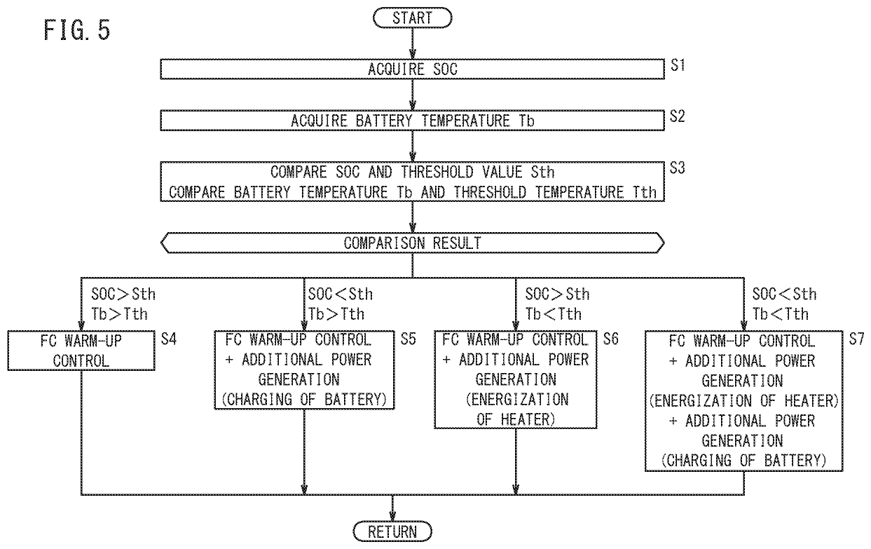

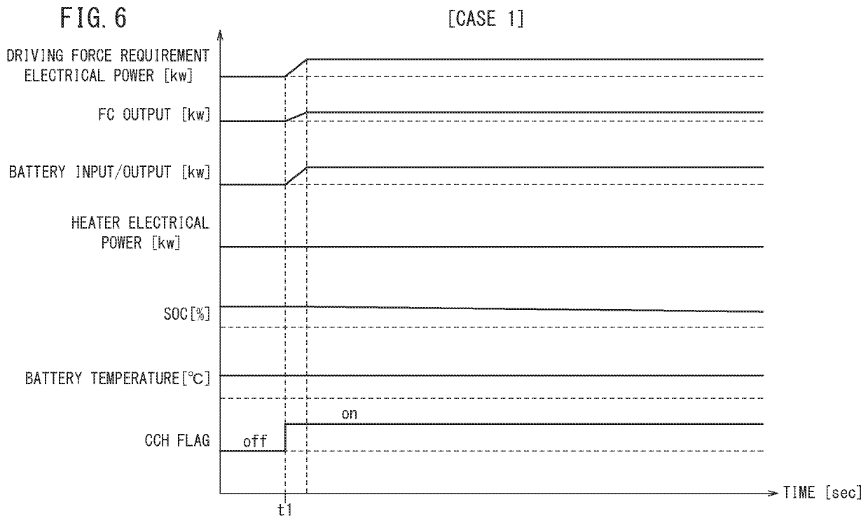

More specifically, certain processing operations of the FC control unit 60 will be described with reference to the table of FIG. 4, the flowchart of FIG. 5, and the time charts shown in FIGS. 6 to 9.

First, in step S1 of FIG. 5, the FC control unit 60 acquires the SOC of the battery 40 from the SOC sensor 80. In step S2, the FC control unit 60 acquires the battery temperature Tb from the temperature sensor 82.

In step S3, the FC control unit 60 compares the SOC of the battery 40 with a preset threshold value Sth, and compares the battery temperature Tb with a preset threshold temperature Tth.

As a result of the comparison, in the case that the SOC of the battery 40 is higher than the threshold value Sth, and the battery temperature Tb is higher than the threshold temperature Tth (refer to Case 1 in FIG. 4), the process proceeds to step S4, and the FC control unit 60 performs the warm-up control so that the amount of generated power of the FC unit 20 is minimized.

More specifically, as shown in FIG. 6 (Case 1), at time t1, at a stage at which there is a driving force requirement made with respect to the motor 14, the FC control unit 60 sets a CCH (warm-up) flag to ON, and the warm-up control is performed in a manner so as to minimize the amount of generated power of the FC unit 20.

In step S4, basically, the electrical power corresponding to the driving force requirement is taken out from the battery 40, and in the case that the electrical power of the battery 40 is insufficient, the insufficient electrical power is supplemented by the electrical power generated by the FC unit 20. Further, because the temperature of the battery 40 is high, the electrical power supplied to the battery heater 43 is 0 kW.

Because the driving force requirement is covered by the electrical power from the battery 40, the SOC of the battery 40 tends to decrease over time. Moreover, in Case 1, the battery 40 is maintained at a high temperature.

On the other hand, in the comparison of the aforementioned step S3 of FIG. 5, in the case that the SOC of the battery 40 is lower than the threshold value Sth, and the battery temperature Tb is higher than the threshold temperature Tth (Case 2), the process proceeds to step S5, and the FC control unit 60, in addition to the electrical power for the warm-up control, carries out additional power generation within a range in which the battery 40 is capable of being charged.

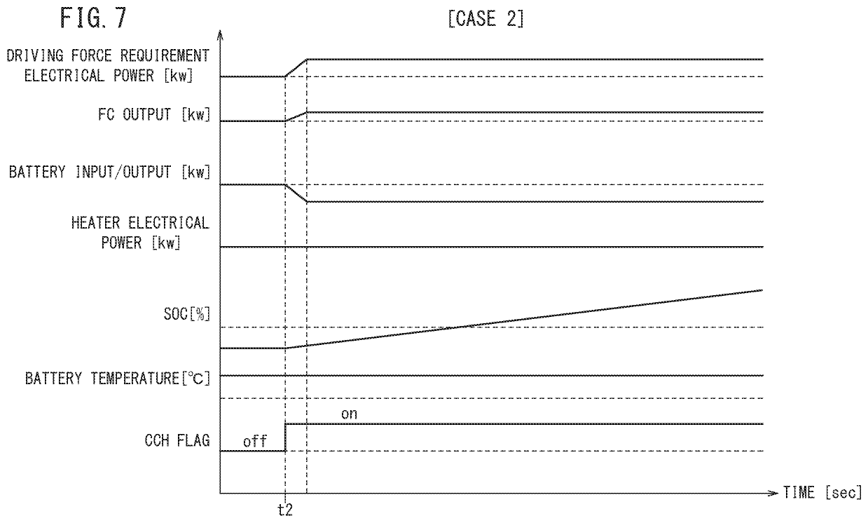

More specifically, as shown in FIG. 7, at time t2, at a stage at which there is a driving force requirement made with respect to the motor 14, the FC control unit 60 sets the CCH (warm-up) flag to ON, and in the FC unit 20, the warm-up control is initiated, and furthermore, surplus electrical power due to additional power generation, which is implemented together with the warm-up control, is supplied to the battery 40, and charging of the battery 40 is carried out. From the fact that the SOC of the battery 40 is lower than the threshold value Sth, the driving force requirement is not covered by the electrical power from the battery 40.

Moreover, because the temperature of the battery 40 is high, the electrical power supplied to the battery heater 43 is 0 kW. The SOC of the battery 40 rises because the battery 40 is charged with the surplus electrical power from the FC unit 20.

On the other hand, in the aforementioned step S3 of FIG. 5, in the case that the SOC of the battery 40 is higher than the threshold value Sth, and the battery temperature Tb is lower than the threshold temperature Tth (Case 3), the process proceeds to step S6, and the FC control unit 60, in addition to the electrical power for the warm-up control, carries out additional power generation within a range in which at least the battery heater 43 is capable of being energized.

In Case 3, basically, charging or discharging of the battery 40 is not carried out. In the case that the driving power requirement is large, or in the case that the electrical power supplied to the battery heater 43 is insufficient, the electrical power of the battery 40 is supplemented.

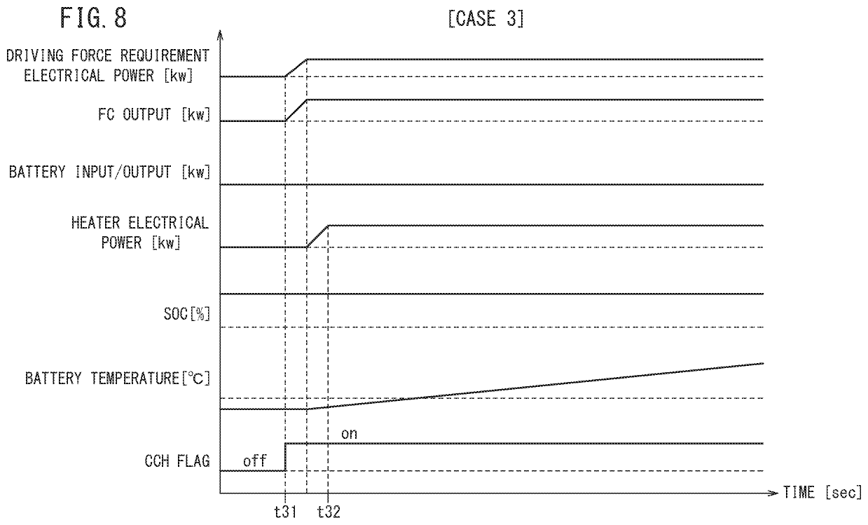

More specifically, as shown in FIG. 8, at time t31, at a stage at which there is a driving force requirement made with respect to the motor 14, the FC control unit 60 sets the CCH (warm-up) flag to ON, and in the FC unit 20, the warm-up control is initiated, and thereafter, at time t32, surplus electrical power due to additional power generation is supplied to the battery heater 43, and the temperature of the battery 40 is raised.

Moreover, in Case 3, because the SOC of the battery 40 is high, charging of the battery 40 in the manner described above basically cannot be performed.

In the aforementioned step S3 of FIG. 5, in the case that the SOC of the battery 40 is lower than the threshold value Sth, and the battery temperature Tb is less than the threshold temperature Tth (Case 4), the process proceeds to step S7, and the FC control unit 60, in addition to the electrical power for the warm-up control, carries out additional power generation within a range in which the battery heater 43 is capable of being energized. Furthermore, from a point in time at which the battery temperature Tb has exceeded the threshold temperature Tth, additional power generation is carried out within a range in which the battery 40 is capable of being charged.

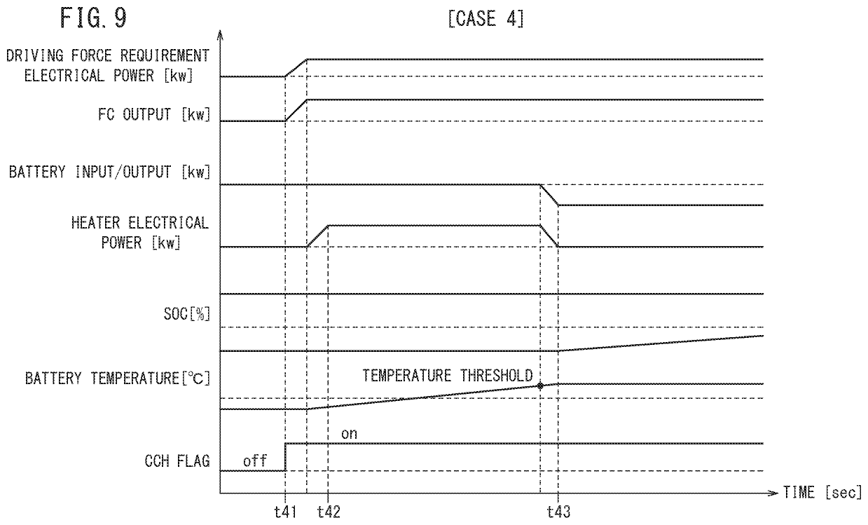

More specifically, as shown in FIG. 9, at time t41, at a stage at which there is a driving force requirement made with respect to the motor 14, the FC control unit 60 sets the CCH (warm-up) flag to ON, and the warm-up control is initiated in the FC unit 20. Thereafter, at time t42, surplus electrical power due to additional power generation is supplied to the battery heater 43, and the temperature of the battery 40 is raised. In Case 4, basically, although charging or discharging of the battery 40 is not carried out, the battery 40 is charged from a point in time t43 at which the battery temperature Tb has exceeded the threshold temperature Tth.

In addition, as described above, from the point in time t43 at which the battery temperature Tb has exceeded the threshold temperature Tth, charging with respect to the battery 40 is executed, and accordingly, the SOC of the battery increases.

The embodiment described above can be summarized in the following manner.

The FC system (10) according to the present embodiment includes the load (motor (14), etc.), the FC unit (20) connected to the load and configured to selectively supply electrical power to the load, the battery (40) connected to the load and configured to selectively supply electrical power to the load, the battery heater (43) configured to supply heat to the battery (40), and the FC control unit (60) configured to perform at least the warm-up control of the FC unit (20), wherein the FC control unit (60) selectively supplies the electrical power of the FC unit (20) to one or both of the battery (40) and the battery heater (43), based on at least one of whether the state of charge (SOC) of the battery (40) is higher or lower than the preset threshold value (Sth), and whether the battery temperature (Tb) is higher or lower than the preset threshold temperature (Tth).

Conventionally, when power is generated simply in accordance with the driving force requirement, time is required for warming up the FC. Conversely, when priority is placed on the warm-up control, there is a concern that the driving force requirement may be insufficient. According to the present embodiment, the electrical power of the fuel cell is selectively supplied to one or both of the battery (40) and the battery heater (43), based on at least one of whether the state of charge of the battery (40) is higher or lower than the preset threshold value (Sth), and whether the battery temperature (Tb) is higher or lower than the preset temperature threshold (Tth). Therefore, it is possible to realize an improvement in the warm-up performance along with generating electrical power corresponding to the driving force requirement, thereby enabling a reduction in the frequency at which the driving force is limited.

In the FC system according to the present embodiment, the FC control unit (60) selectively supplies the surplus electrical power of the FC unit (20) to one or both of the battery (40) and the battery heater (43), based on at least one of whether the state of charge of the battery (40) is higher or lower than the threshold value (Sth), and whether the battery temperature (Tb) is higher or lower than the temperature threshold (Tth).

In accordance with this feature, in the case that the electrical power of the battery (40) is decreasing with respect to the driving force requirement, the surplus electrical power of the FC unit (20) is supplied to (charges) the battery (40). In the case that the battery temperature (Tb) is decreasing, the surplus electrical power of the FC unit (20) is supplied to the battery heater (43) to thereby increase the battery temperature (Tb). Consequently, the surplus electrical power of the FC unit (20) can be effectively used to charge the battery (40) and to supply electrical power to the battery heater (43), and it is possible to realize an improvement in the warm-up performance along with generating electrical power corresponding to the driving force requirement.

In the present embodiment, in the case that the state of charge of the battery (40) is lower than the threshold value (Sth) and that the battery temperature (Tb) is higher than the threshold temperature (Tth), the FC control unit (60) supplies the surplus electrical power of the FC unit (20) to the battery (40).

In accordance with this feature, in the case that the state of charge of the battery (40) is lower than the threshold value (Sth), and the battery temperature (Tb) is higher than the threshold temperature (Tth), by supplying the surplus electrical power of the FC unit (20) to the battery (40), the surplus electrical power of the FC unit (20) can be effectively used for charging the battery (40), and it is possible to realize an improvement in the warm-up performance along with generating electrical power corresponding to the driving force requirement.

In the present embodiment, in the case that the state of charge of the battery (40) is higher than the threshold value (Sth) and that the battery temperature (Tb) is lower than the threshold temperature (Tth), the FC control unit (60) supplies the surplus electrical power of the FC unit (20) to the battery heater (43).

In the case that the state of charge of the battery (40) is higher than the threshold value (Sth), and the battery temperature (Tb) is lower than the threshold temperature (Tth), by supplying the surplus electrical power of the FC unit (20) to the battery heater (43), the surplus electrical power of the FC unit (20) can be effectively used for supplying electrical power to the battery heater (43), and it is possible to realize an improvement in the warm-up performance along with generating electrical power corresponding to the driving force requirement.

In the present embodiment, in the case that the state of charge of the battery (40) is lower than the threshold value (Sth) and that the battery temperature (Tb) is lower than the threshold temperature (Tth), the FC control unit (60) supplies the surplus electrical power of the FC unit (20) to the battery heater (43), and after the battery temperature (Tb) has reached the threshold temperature (Tth), supplies the surplus electrical power of the FC unit (20) to the battery (40).

The surplus electrical power of the FC unit (20) can be effectively used to charge the battery (40) and to supply electrical power to the battery heater (43), and it is possible to realize an improvement in the warm-up performance along with generating electrical power corresponding to the driving force requirement.

The present invention is not limited to the embodiments described above, and based on the disclosed content of the present specification, it is a matter of course that a variety of alternative configurations may be adopted therein.

What is claimed is:

1. A fuel cell system, comprising:
a load;
a fuel cell connected to the load and configured to selectively supply electrical power to the load;
a battery connected to the load and configured to selectively supply electrical power to the load;
a battery heater configured to supply heat to the battery; and
a power control unit configured to perform at least a warm-up control of the fuel cell;
wherein the power control unit selectively supplies the electrical power of the fuel cell to one or both of the battery and the battery heater, based on at least one of whether a state of charge of the battery is higher or lower than a preset threshold value, and whether a battery temperature is higher or lower than a preset threshold temperature.

2. The fuel cell system according to claim 1, wherein the power control unit selectively supplies a surplus electrical power of the fuel cell to one or both of the battery and the battery heater, based on at least one of whether the state of charge of the battery is higher or lower than the threshold value, and whether the battery temperature is higher or lower than the temperature threshold.

3. The fuel cell system according to claim 2, wherein, in a case that the state of charge of the battery is lower than the threshold value and that the battery temperature is higher than the threshold temperature, the power control unit supplies the surplus electrical power of the fuel cell to the battery.

4. The fuel cell system according to claim 3, wherein the power control unit is configured to initiate the warm-up control in the fuel cell, and carry out charging of the battery, by further supplying to the battery surplus electrical power due to additional power generation implemented together with the warm-up control.

5. The fuel cell system according to claim 2, wherein, in a case that the state of charge of the battery is higher than the threshold value and that the battery temperature is lower than the threshold temperature, the power control unit supplies the surplus electrical power of the fuel cell to the battery heater.

6. The fuel cell system according to claim 5, wherein the power control unit is configured to initiate the warm-up control in the fuel cell, and raise the temperature of the battery, by further supplying to the battery heater surplus electrical power due to additional power generation.

7. The fuel cell system according to claim 2, wherein, in a case that the state of charge of the battery is lower than the threshold value and that the battery temperature is lower than the threshold temperature, the power control unit supplies the surplus electrical power of the fuel cell to the battery heater, and after the battery temperature has reached the threshold temperature, supplies the surplus electrical power of the fuel cell to the battery.

8. The fuel cell system according to claim 7, wherein the power control unit, in addition to the electrical power for the warm-up control, carries out additional power generation within a range in which the battery heater is configured to be energized, and from a point in time at which the battery temperature has exceeded the threshold temperature, carries out additional power generation within a range in which the battery is configured to be charged.

9. A method of controlling a fuel cell system, the fuel cell system comprising:
a load;
a fuel cell connected to the load and configured to selectively supply electrical power to the load;
a battery connected to the load and configured to selectively supply electrical power to the load;
a battery heater configured to supply heat to the battery; and
a power control unit configured to perform at least a warm-up control of the fuel cell;
wherein the method of controlling the fuel cell system comprises selectively supplying the electrical power of the fuel cell to one or both of the battery and the battery heater, based on at least one of whether a state of charge of the battery is higher or lower than a preset threshold value, and whether a battery temperature is higher or lower than a preset threshold temperature.

10. The method of controlling the fuel cell system according to claim 9, further comprising selectively supplying a surplus electrical power of the fuel cell to one or both of the battery and the battery heater, based on at least one of whether the state of charge of the battery is higher or lower than the threshold value, and whether the battery temperature is higher or lower than the temperature threshold.

11. The method of controlling the fuel cell system according to claim 10, further comprising supplying the surplus electrical power of the fuel cell to the battery, in a case that the state of charge of the battery is lower than the threshold value and that the battery temperature is higher than the threshold temperature.

12. The method of controlling the fuel cell system according to claim 11, further comprising initiating the warm-up control in the fuel cell, and carrying out charging of the battery, by further supplying to the battery surplus electrical power due to additional power generation implemented together with the warm-up control.

13. The method of controlling the fuel cell system according to claim 10, further comprising supplying the surplus electrical power of the fuel cell to the battery heater, in a case that the state of charge of the battery is higher than the threshold value and that the battery temperature is lower than the threshold temperature.

14. The method of controlling the fuel cell system according to claim 13, further comprising initiating the warm-up control in the fuel cell, and raising the temperature of the battery, by further supplying to the battery heater surplus electrical power due to additional power generation.

15. The method of controlling the fuel cell system according to claim 10, further comprising supplying the surplus electrical power of the fuel cell to the battery heater in a case that the state of charge of the battery is lower than the threshold value and that the battery temperature is lower than the threshold temperature, and after the battery temperature has reached the threshold temperature, supplying the surplus electrical power of the fuel cell to the battery.

16. The method of controlling the fuel cell system according to claim 15, further comprising performing, in addition to the electrical power for the warm-up control, carrying out additional power generation within a range in which the battery heater is configured to be energized, and from a point in time at which the battery temperature has exceeded the threshold temperature, carrying out additional power generation within a range in which the battery is configured to be charged.
